(19) United States
(12) Patent Application Publication
(10) Pub. No.: US 2004/0075941 A1
(43) Pub. Date: Apr. 22, 2004

(54) Manufacturing method of front core for magnetic erase head and front core for magnetic erase head produced thereby

(75) Inventor: Kazuki Soejima, Osaka (JP)

Correspondence Address: CROWELL & MORING LLP, INTELLECTUAL PROPERTY GROUP, P.O. BOX 14300, WASHINGTON, DC, 20044-4300, US

(73) Assignee: Funai Electric Co., Ltd.

(21) Appl. No.: 10/683,447

(22) Filed: Oct. 14, 2003

(30) Foreign Application Priority Data
Oct. 15, 2002 (JP) 2002-300240

(51) Int. Cl. G11B 5/127

(52) U.S. Cl. 360/118

(57) ABSTRACT

A front core for a magnetic erase head is produced by a method that includes forming a pair of elongate magnetic bars by sintering such that they can be combined with a gap therebetween, holding the magnetic bars with a predetermined space to form a recess and a gap groove, pouring a resin into the recess and the gap groove to join the magnetic bars, and grinding the magnetic bars joined to each other. This allows the recess and the gap groove to be formed through no cutting process, thus contributing to reduction in time required for the process and to decrease in consumption of grindstone for cost reduction.

### BACKGROUND OF THE INVENTION

The present invention relates to a method of manufacturing a front core for a magnetic erase head and a front core produced by the method.

Referring to FIGS. 4 and 5, a description will be made as to a conventional magnetic erase head and a manufacturing method of a front core of the magnetic erase head. As shown in FIG. 4, the magnetic erase head 1 includes a front core 2 and a back core 3, for use in erasure of data recorded on a magnetic tape through the width of the tape. The front core 2 consists mainly of a pair of magnetic bodies 5a and 5b, and it is arranged to face the back core 3. The front core 2 has a gap G formed between the pair of magnetic bodies 5a and 5b. The whole gap G in the front core 2 is filled with an adhesive filler of a non-magnetic material such as an epoxy resin containing a fine powder of SiO2. The face (front surface) of the front core 2 that is defined by the pair of magnetic bodies 5a and 5b and the epoxy resin forms a constant curvature. The back core 3 has a coil 4 wound therearound. The magnetic erase head 1 configured in the above manner erases signals recorded on a magnetic tape by applying to the magnetic tape an alternating magnetic field generated, in the gap G, by applying an alternating current to the coil 4, when the magnetic tape slides along the front surface of the front core 2 from one of the magnetic bodies, e.g., the magnetic body Sa, across the gap G to the other magnetic body 5b.

As shown in FIG. 5, the front core 2 for use in the magnetic erase head 1 has been conventionally made from a flat core material 10. The flat core material 10 shown in FIG. 5A is formed from a magnetic material such as a ferrite. For example, 160 front cores, 16 pieces in the transverse direction and 10 pieces in the depth direction, can be made from a single flat core material. First, as shown in FIG. 5B, recesses 11 and separation grooves 12 are cut in the flat core material 10 along its depth direction. A respective section separated by the separation grooves 12 corresponds to a front core in the cross section. Then, as shown in FIG. 5C, a gap groove 13 is cut at the center of the bottom of each recess 11. Then, as shown in FIG. 5D, a resin 6 is poured into the recesses 11 and the gap grooves 13. Then, as shown in FIG. 5E, the flat core material 10 is separated along the separation grooves 12 into sixteen bars 14, in this example, each including the resin 6. Then, as shown in FIG. 5F, a side of each bar 14 that corresponds to the front side of the front core is ground roughly. The rough grinding is continued until the resin 6 in the gap groove 13 is exposed, whereby the bar 14 of an integral magnetic body is divided into a pair of magnetic bodies 50a and 50b with the gap G formed. At this stage, the surface corresponding to the front surface of the front core is a rough cylindrical surface R with a constant curvature. Then, as shown in FIG. 5G, the surface is polished so as to produce an elongate front core 15 of which the cylindrical surface R has become smooth. Then, as shown in FIG. 5H, the elongate front core 15 is cut into a plurality of front cores each having a predetermined length. In this example, ten front cores are produced per a bar. After finishing of the cut surfaces or other treatments, the process of manufacturing the front core is completed. Such a process is disclosed in, for example, Japanese utility model registration No. 3081666.

However, the above-described method, in which the front cores are made from the flat core material, requires the cutting processes respectively performed for a plurality of front cores in order to form the recesses, the gap grooves, and the separation grooves, and it has been desired to reduce the processing steps and the time required therefor. Further, the cutting processes are performed using an expensive whetstone. The elimination of the steps can reduce the quantity of whetstone consumed, thus contributing to cost reduction.

### SUMMARY OF THE INVENTION

The present invention has been made to solve the above mentioned problems. An object of the present invention is to provide a method of manufacturing a front core for a magnetic erase head that allows the steps of cutting the recesses, the gap grooves, and the separation grooves to be eliminated so as to reduce the time required for the process and to decrease the consumption of grindstone for cost reduction, and also to provide a front core for a magnetic erase head that is produced by the above method.

An aspect of the present invention provides a method of manufacturing a front core for a magnetic erase head, the front core including a pair of magnetic bodies with a gap therebetween, the gap being filled with a non-magnetic material, the front core being used in combination with a back core having a coil wound therearound, the method comprising the steps of holding a pair of elongate magnetic bars as core materials together such that the magnetic bars are positioned in facing relationship with the gap formed therebetween; filling the gap with the non-magnetic material to join the pair of magnetic bars; grinding the magnetic bars to form an elongate front core having a surface defined by the pair of bars and the non-magnetic material filling the gap; and cutting the elongate front core into a plurality of front cores each having a predetermined length.

The above method allows the gap groove to be formed, without any cutting process, only by holding the pair of elongate magnetic bars such that they face each other with a predetermined space.

Another aspect of the present invention provides a method of manufacturing a front core for a magnetic erase head, the front core including a pair of magnetic bodies with a gap therebetween, the gap being filled with a non-magnetic material, the front core being used in combination with a back core having a coil wound therearound, the method comprising the steps of: forming a pair of elongate magnetic bars as core materials by sintering such that the magnetic bars can be combined with a predetermined gap therebetween; holding the pair of magnetic bars together such that the magnetic bars are positioned in facing relationship with the gap formed therebetween; filling the gap with the non-magnetic material to join the pair of magnetic bars; grinding the magnetic bars to form an elongate front core having a surface defined by the pair of bars and the non-magnetic material filling the gap; and cutting the elongate front core into a plurality of front cores each having a predetermined length.

Since the above method uses a pair of elongate magnetic bars formed by sintering such that they can be combined with the gap therebetween, it allows the gap groove to be formed, without any cutting process, only by holding the magnetic bars such that they face each other with a predetermined space as well as allowing the magnetic bars to be configured in a desired manner.

### BRIEF DESCRIPTION OF THE DRAWINGS

FIGS. 1A and 1B are perspective views of a core material, for illustrating the steps of a manufacturing method of a front core according to an embodiment of the present invention, FIGS. 1C, 1D, and 1E are cross sectional views of the same with a resin provided, and FIG. 1F is a perspective view of an elongate front core and separated front cores, for schematically illustrating the cutting step in the method.

FIG. 2A is a flowchart showing the same method and FIG. 2B is a flowchart showing a conventional method of manufacturing front cores.

FIGS. 3A and 3B are perspective views of a core material, for illustrating the steps of a manufacturing method of a front core according to another embodiment of the present invention and FIGS. 3C, 3D, and 3E are cross sectional views of the same with a resin provided.

FIG. 4 is a perspective view of a magnetic erase head to which either of the present invention and the prior art is applied.

FIG. 5A is a perspective view of a flat core material, for illustrating the steps of a conventional method of manufacturing a front core, FIGS. 5B and 5C are cross sectional views of the core material at the respective steps, FIGS. 5D-5G are cross sectional views of the same with a resin provided, and FIG. 5H is a perspective view of an elongate front core and separated front cores, for schematically illustrating the cutting step in the conventional method.

### DETAILED DESCRIPTION OF THE PREFERRED EMBODIMENT

Referring now to the accompanying drawings, a description will be made as to a method of manufacturing a front core for a magnetic erase head according to an embodiment of the present invention and a front core for a magnetic erase head produced by the method. Like parts in the drawings are denoted by like numerals and the explanation will not be repeated.

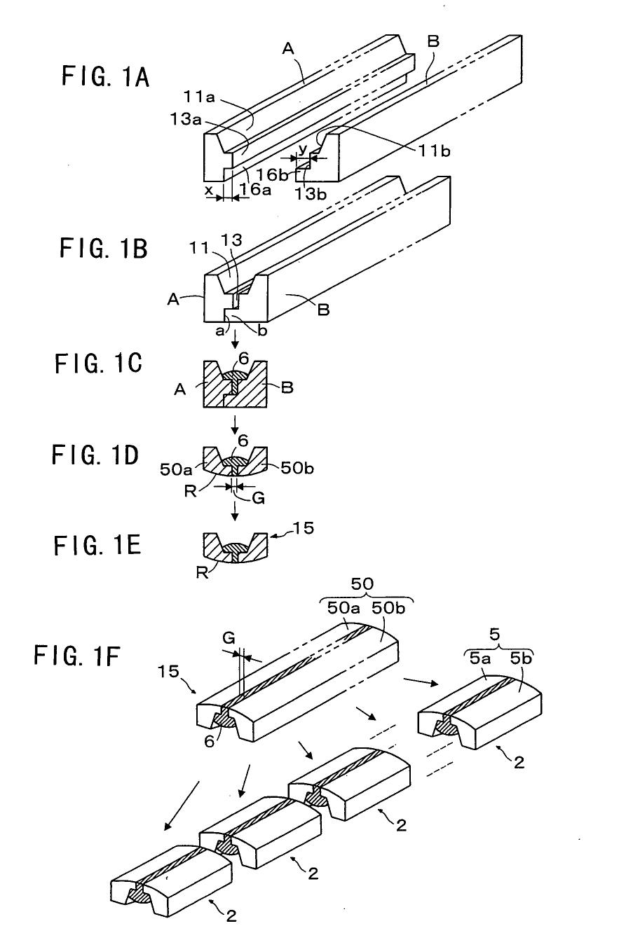

In this embodiment, the front core is made from core materials A and B shown in FIG. 1A that are formed by sintering. The core materials A and B are formed from a magnetic material such as a ferrite and configured to be like bars that have uniform cross sections, which are different from each other, and a length of ten front cores for example. The core material A has a sloping surface 11a formed by cutting diagonally the upper right part (as viewed in FIG. 1) of a first rectangular parallelepiped, a recess 16a formed by cutting the lower right part (as viewed in FIG. 1) that is rectangular in cross section and has a width of x, and a surface 13a of the first rectangular parallelepiped. The core material B has a sloping surface 11b formed by cutting diagonally the upper left part (as viewed in FIG. 1) of a second rectangular parallelepiped identical in size to the first rectangular parallelepiped, a projection 16b that projects from the second rectangular parallelepiped and that is rectangular in cross section with a width of y, and a surface 13b of the second rectangular parallelepiped. The width y is greater than the width x. Then, as shown in FIG. 1B, the core materials A and B are held together such that the sloping surfaces 11a and 11b face each other and the projection 16b abuts against a wall of the recess 16a. The width y greater than the width x causes a distance between the surfaces 13a and 13b, which define a gap groove 13. The widths x and y are determined such that the difference between them, i.e. the distance between the surfaces 13a and 13b, corresponds to a gap G, which will be described below. The sloping surfaces 11a and 11b positioned in facing relationship define a recess 11.

Then, as shown in FIG. 1C, a resin 6 is poured into the recess 11 formed by holding the combination of the core materials A and B and into the gap groove 13 communicating therewith. It should be noted that the upper surface of the projection 16b serves as the bottom of a saucer that can prevent a spillage of the poured resin 6. In order to enhance the resistance to wear, for example, an epoxy resin containing fine powder of SiO2 as a filler is used as the resin 6. This is a non-magnetic material, which can secure, during and after processing described below, the core materials A and B by bonding them, as well as serving as a filler in the gap between the pole pieces after the front core is completed. Then, as shown in FIG. 1D, the under sides (as viewed in the figure) of the core materials A and B, which are bonded to each other with the resin, are roughly ground to form a surface corresponding to the front surface of a front core. The rough grinding is continued until the resin at the gap groove 13 is exposed. Thus, the portion where the core materials A and B overlap one another is removed such that they become a pair of symmetrical magnetic bodies 50a and 50b with the gap G formed therebetween. At this stage, the surface corresponding to the front surface of the front core is a rough cylindrical surface R with a constant curvature. Then, as shown in FIG. 1E, the cylindrical surface R is polished to be smooth, whereby an elongate front core 15 with the smooth cylindrical surface is produced. Then, as shown in FIG. 1F, the elongate front core 15 is cut into a plurality of front cores each having a predetermined length. In this example, ten front cores are produced per a bar. After finishing of the cut surfaces or other treatments, the process of manufacturing the front core is completed.

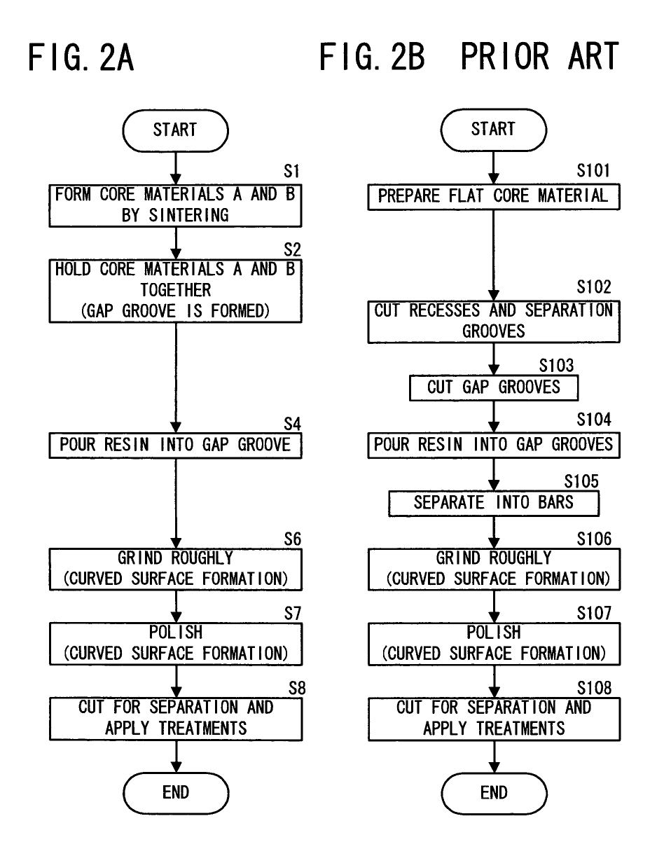

Referring now to FIG. 2, the steps of the method of manufacturing a front core according to the present invention will be described by comparison with the steps of the conventional method. As shown in FIG. 2A, first in the process of manufacturing a front core according to the present invention, the core materials A and B are formed by sintering (S1). In this case, once a metal mold for forming a raw material before sintering is produced, it can be used many times. Thus, only the initial investment is needed. Next, the core materials A and B are held together (S2). This step can be easily accomplished by, for example, holding the core materials with a tool such as a clamp. The next step is pouring a resin into the gap groove (S4), which is followed by two steps of forming the curved surface, i.e., rough grinding and polishing, (S6 and S7). Finally, cutting into separate products and appropriate treatments are performed (S8) to complete the process.

On the other hand, the conventional manufacturing process shown in FIG. 2B starts with preparing a flat core material (S101). Then, cutting of recesses and separation grooves (S102), and further cutting of gap grooves (S103) are performed. The next step of pouring a resin into the gap groove (S104) is substantially the same as the step S4 in the present invention, but the subsequent step of separating into respective bars (S105) requires machining for separation. Three steps following it (S106 to S108) are substantially identical to the steps S6 to S8 in the present invention.

As can be understood from the above, the present invention is advantageous in that it does not require the three steps S102, S103, and S105, i.e., the cutting of the grooves and the like, and the separation into the bars, which require considerable working hours as well as consuming expensive grindstone. Accordingly, even in consideration of the initial investment needed for making the core materials A and B, the present invention has advantages including cost reduction.

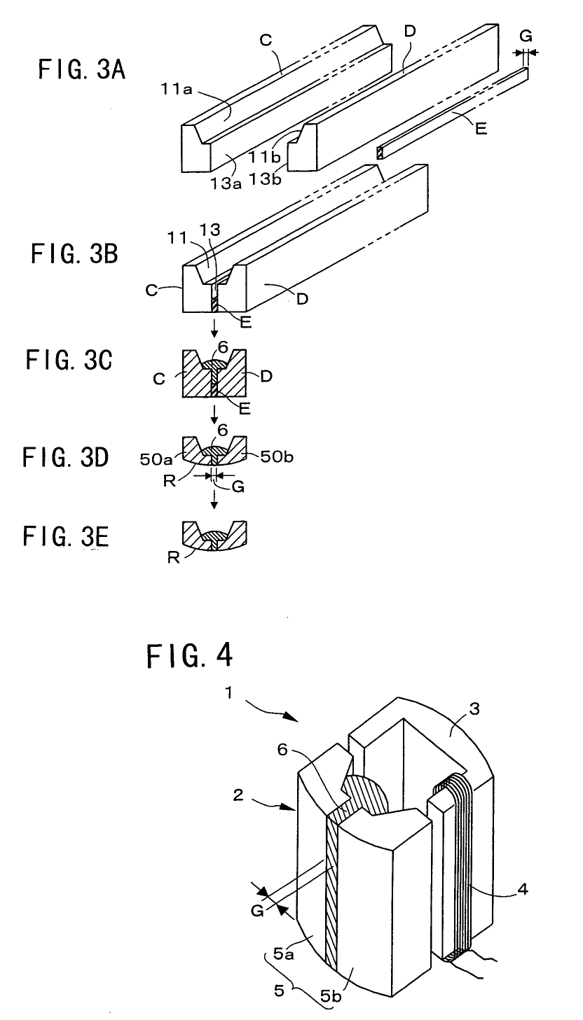

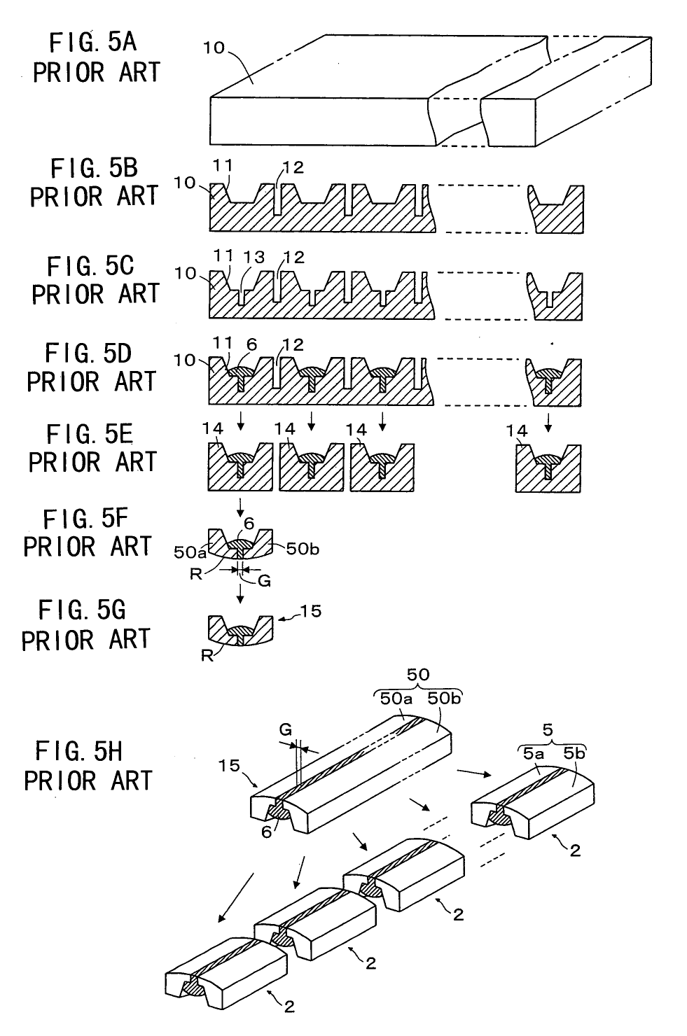

Referring now to FIG. 3, another embodiment of the present invention will be described. According to this embodiment, a front core is made from core materials C and D shown in FIG. 3A that are formed by sintering. Additionally prepared is a spacer E with a thickness corresponding to a gap G in the front core. The core materials C and D are formed from a magnetic material such as a ferrite and configured to be like bars that have uniform cross sections, which are identical to each other because the two core materials are formed using the same metal mold before sintered, and that have a length of ten, for example, front cores respectively. The core material C has a sloping surface 11a formed by cutting diagonally the upper right part (as viewed in FIG. 3) of a first rectangular parallelepiped and a surface 13a of the first rectangular parallelepiped. The core material D is identical in shape to the core material C, and they are arranged in bilateral symmetry. The core material D has a sloping surface 11b formed by cutting diagonally the upper left part (as viewed in FIG. 3) of a second rectangular parallelepiped and a surface 13b of the second rectangular parallelepiped. Then, as shown in FIG. 3B, the core materials C and D are held such that the sloping surfaces 11a and 11b, and the surfaces 13a and 13b face each other respectively with the spacer E sandwiched between the lower parts of the surfaces 13a and 13b. This allows the surfaces 13a and 13b to define a gap groove 13 with the width corresponding to the gap G. The sloping surfaces 11a and 11b, which are positioned in facing relationship, forms a recess 11. Then, as shown in FIGS. 3C, 3D, and 3E, the same processing as described referring to FIG. 1 are performed to produce the front core. This embodiment allows the use of core materials identical in shape to each other, thus requiring only one type of mold. Further, in this embodiment, the gap G can be adjusted freely by varying the thickness of the spacer E.

The present invention is not to be limited by the above described embodiments, but various modifications may be made without departing from the spirit and scope of the invention. For example, instead of abutting the projection 16b against the wall of the recess 16a such that the difference between their widths y and x causes the gap G as shown in FIG. 1, an appropriate gap G may be formed by means of a tool with the width y of the projection 16b reduced.

What is claimed is:

1. A method of manufacturing a front core for a magnetic erase head, the front core including a pair of magnetic bodies with a gap therebetween, the gap being filled with a non-magnetic material, the front core being used in combination with a back core having a coil wound therearound, the method comprising the steps of:
holding a pair of elongate magnetic bars as core materials together such that the magnetic bars are positioned in facing relationship with the gap formed therebetween;
filling the gap with the non-magnetic material to join the pair of magnetic bars;
grinding the magnetic bars to form an elongate front core having a surface defined by the pair of bars and the non-magnetic material filling the gap; and
cutting the elongate front core into a plurality of front cores each having a predetermined length.

2. A method of manufacturing a front core for a magnetic erase head, the front core including a pair of magnetic bodies with a gap therebetween, the gap being filled with a non-magnetic material, the front core being used in combination with a back core having a coil wound therearound, the method comprising the steps of:
forming a pair of elongate magnetic bars as core materials by sintering such that the magnetic bars can be combined with a predetermined gap therebetween;
holding the pair of magnetic bars together such that the magnetic bars are positioned in facing relationship with the gap formed therebetween;
filling the gap with the non-magnetic material to join the pair of magnetic bars;
grinding the magnetic bars to form an elongate front core having a surface defined by the pair of bars and the non-magnetic material filling the gap; and
cutting the elongate front core into a plurality of front cores each having a predetermined length.

3. A front core for a magnetic erase head produced by the method of claim 1.

4. A magnetic erase head comprising the front core according to claim 3 and a back core having a coil wound therearound.
